(19) United States
(12) Patent Application Publication
(10) Pub. No.: US 2024/0070586 A1
(43) Pub. Date: Feb. 29, 2024

(54) SURVEILLANCE TOOL TO MONITOR ILLEGAL WORKPLACE WHISTLEBLOWER RETALIATION

(71) Applicant: Eric T. Young, Fairfield, CT (US)

(72) Inventor: Eric T. Young, Fairfield, CT (US)

(21) Appl. No.: 18/455,866

(22) Filed: Aug. 25, 2023

Related U.S. Application Data
(60) Provisional application No. 63/401,253, filed on Aug. 26, 2022.

(51) Int. Cl. G06Q 10/0635; G06Q 10/107

(52) U.S. Cl. CPC G06Q 10/0635; G06Q 10/107

(57) ABSTRACT

A processor-implemented whistleblower retaliation surveillance method includes executing processor-executable instructions to receive whistleblower identification and identification of electronic communications to surveil, comparing contents of the electronic communications to patterns of communication indicative of whistleblower retaliation; and issuing alerts when the patterns of communication indicative of whistleblower retaliation are detected in the electronic communications. A computing system includes a retaliation model subsystem, a computer readable memory; a processor in communication with the retaliation model subsystem; and a reporting subsystem. The system monitors communications for indicia of whistleblower retaliation. The retaliation model subsystem specifies patterns of communication that indicate whistleblower retaliation. The processor performs the processor-implemented whistleblower retaliation surveillance method. The reporting subsystem delivers the alerts to designated personnel.

### CROSS-REFERENCE TO RELATED APPLICATION

This application claims the benefit of priority of U.S. provisional application No. 63/401,253, filed Aug. 26, 2022, the contents of which are herein incorporated by reference.

### BACKGROUND OF THE INVENTION

The present invention relates to surveillance tools and, more particularly, to a surveillance tool to monitor illegal workplace retaliation.

Retaliation is illegal against employees who “whistle blow” (i.e., raise integrity issues). Whistleblowing exists around the world, and worse, retaliation is dramatically rising. There are many studies which demonstrate that the employee fear of retaliation continues to increase globally, and retaliation exists in 77% of companies today according to the Ethics & Compliance Initiative (ECI) as of 2021. That has nearly doubled in two years and tripled in the past three to four years. Qui tam complaints typically trigger government investigations but proving retaliation against whistleblowers is occurring or has occurred has traditionally been difficult. This illegal act must be detected and prevented to enable safe whistleblowing to protect communities and employees.

Tools exist to track the volume and type of whistleblowers/issues raised by whistleblowers, and there are systems which monitor fraud, financial crimes, and even bullying. However, there is presently no monitoring tool to detect and prevent retaliation, whether explicit retaliation or more subtle forms of retaliation against whistleblowers. The currently available systems do not target the multiple behaviors and communications between managers and others who conspire to retaliate against whistleblower employees. There lack of existing tools prevents whistleblowers from raising control weaknesses, fraud, or crimes without the fear of retaliation and intimidation.

As can be seen, there is a need for a surveillance tool that can detect whistleblower retaliation in order for fraud, financial crimes, and other crimes from occurring.

### SUMMARY OF THE INVENTION

In one aspect of the present invention, a processor-implemented whistleblower retaliation surveillance method comprises executing processor-executable instructions to 1) receive whistleblower identification and identify electronic communications to surveil; 2) compare contents of the electronic communications to patterns of behavior indicative of whistleblower retaliation; and issue alerts and prompt investigations when the patterns of communication indicative of whistleblower retaliation are detected in the electronic communications.

In another aspect of the present invention, a computing system operative to monitor communications for indicia of whistleblower retaliation, comprises a retaliation model subsystem operative to specify patterns of communication indicative of whistleblower retaliation; a computer readable memory; a processor in communication with the retaliation model subsystem and with the computer readable memory, said processor operative to execute computer readable instructions that, when executed, perform the processor-implemented whistleblower retaliation surveillance method; and a reporting subsystem operative to deliver the alerts to designated personnel to investigate and prosecute the illegal retaliation against the whistleblower.

These and other features, aspects and advantages of the present invention will become better understood with reference to the following drawings, description, and claims.

### BRIEF DESCRIPTION OF THE DRAWINGS

FIG. 1 is a flowchart of a process of establishing a workplace retaliation monitoring system according to an embodiment of the present invention;

FIG. 2 is a flowchart of a process of monitoring workplace retaliation according to an embodiment of the present invention;

FIG. 3 is a graphic display thereof;

FIG. 4 is a block diagram illustrating the role of the consultant in FIGS. 2-3; and

FIG. 5 is a block diagram of a general and/or special purpose computer according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a collaboration of two types of companies: those which intake whistleblower complaints (“intake companies”) and those which have tools to monitor employee and/or institutional misconduct such as illegal trading of securities, executing financial crimes, or workplace and/or sexual harassment (“monitoring companies”). The present invention enables a corporation, university, or other organization of intake companies and monitoring companies to prevent, detect, and/or act on whistle blower retaliation.

Intake companies already collect whistleblowing data but do not monitor retaliation. Monitoring companies already compile social media, emails, texts, and business transactions, to monitor financial crimes or workplace and/or sexual harassment. However, there are no tools which combine said companies to target managers and others, including Human Resources, who conspire and retaliate against whistleblowers, combining tools of said companies for monitoring against whistleblowing retaliation.

Combining the utility of existing devices and services of (1) whistleblowing hotline companies with (2) the surveillance capabilities of transactions and behavior of electronic communications to monitor financial crimes, trading misconduct and workplace and/or sexual harassment significantly improves the ability for companies to deter, detect and prevent retaliation against employees who raise integrity issues by blowing the whistle.

Whistleblower vendors (intake companies) intake whistleblower complaints on an anonymous or named basis when hired by companies to intake/collect/help trigger company investigations to assess whether the whistleblowing complaint is legitimate. They may work with and collaborate with internal investigators and/or outside counsel, who utilize surveillance technology vendors (monitoring companies) that have the software to monitor trade or other business transactions as well as surveil social media, emails, texts, and other electronic communications to monitor patterns of behavior and dialogue with others which could assess misconduct (including retaliation). Vendors have not yet correlated bad behavior with retaliatory behavior. The present invention may be promoted to prospective and existing clients who require investigative, consultative, expert witness, litigation support, or other services to ultimately lower the fear of retaliation, if not the actual retaliation rates, to create a safe environment for employees to raise concerns, and in turn to protect employees, customers, communities, and stakeholders, including shareholders.

The market and data are ripe to harvest, and the technology exists. What does not exist is the idea to combine whistleblowing vendor data with surveillance technology to monitor retaliatory misconduct.

It's win-win-win for whistleblowers, companies themselves (to protect from reputational damage for retaliation allegations or worse, suppression of real issues raised by whistleblowers), and the vendors and consultants involved to combine a whistleblower vendor with surveillance technology to produce a retaliation monitoring tool for investigative, consulting, monitoring, and litigation support services. As with existing surveillance monitoring tools, rules/thresholds are created (buzz words, common terminology, or code names) which trigger exceptions for compliance and other investigators to assess and investigate. Human Resources, Employee Relations, Compliance and Legal departments may utilize the tool through a licensing agreement and/or the whistleblowing company powered by the surveillance technology firm. The present invention may be used on a preventative basis to monitor for retaliatory behavior, on a detective basis to investigate, or after the fact for litigation support or deferred prosecution agreement requiring independent monitors to validate that remediation is occurring.

Government agencies may benefit by using the inventive method to monitor whistleblower retaliation within or across agencies or to monitor government contractors who might be overcharging the government. The government could utilize the present invention to target retaliators more accurately against whistleblowing employees who want to help the government combat abuse (in the healthcare, aviation, private contractor, or other industries which support the government or utilize government services/property).

The inventive system is operative to perform behavior and lexicon monitoring by crawling through data from one or more communication routes selected from the group consisting of emails, voicemail, texts, recordings of video conferences, and social media, using artificial intelligence to look at workplace harassment, unusual behavior, and/or collusion. For example, evidence of explicit retaliation may include conversations internally between a manager and human resources (HR) communicating that John Doe needs to be fired because he made complaints. Implicit indicia of retaliation may include subtle dialog and/or correlations between a whistleblower report and failure to promote the whistleblower. Over time, this behavior can make the whistleblower feel isolated and unappreciated. The system may identify individual retaliation incidents and may also be used to identify systemic and/or pervasive patterns of behavior. Analysis of the monitored data may reveal evidence of a coverup. Company communications may be monitored, and, in some cases, employees' personal devices may also be monitored. Data mined from whistleblower complaints of wrongdoing may be investigated by the employee's company, e.g., a bank, and evaluated for suspicious communications to confirm whether bona fide retaliation has occurred. Monitoring may be done in real time and/or after the fact, e.g., audit trails of conversations as a part of a discovery process. For profit and non-profit organizations alike may benefit from the inventive monitoring system. Fraud may be detected and prevented because widespread employee knowledge that patterns of retaliation are being monitored will cause a chilling effect to retaliate. Employees may be more willing to raise integrity complaints because they feel safer; preventing retaliation may in turn prevent fraud, or more importantly, avoid physical illness, death, or loss of customer money.

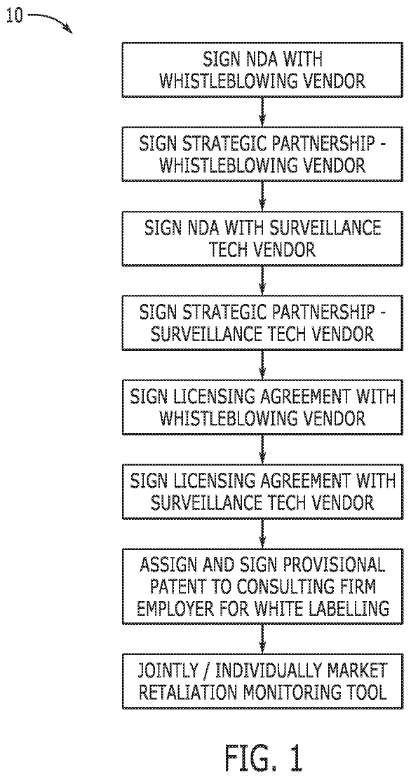

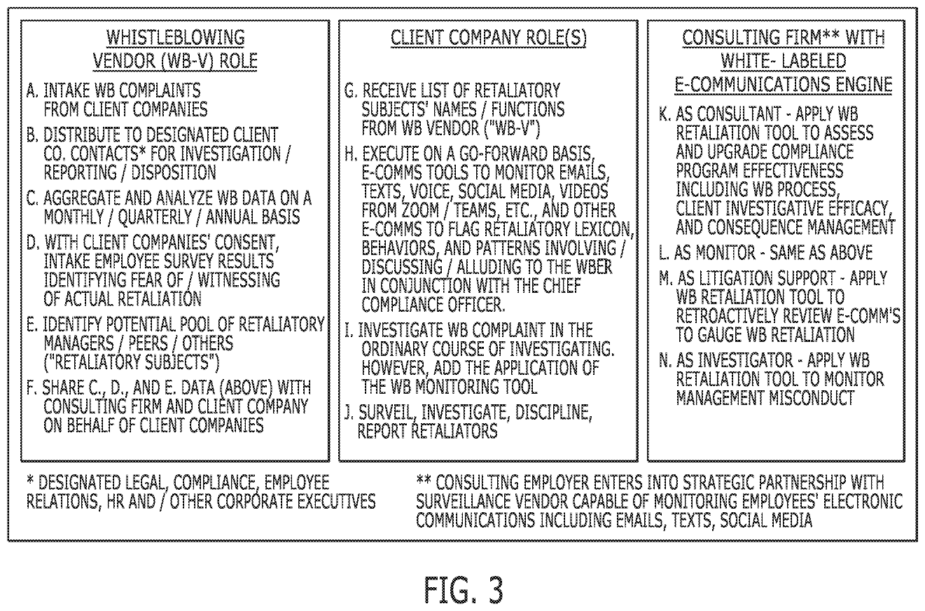

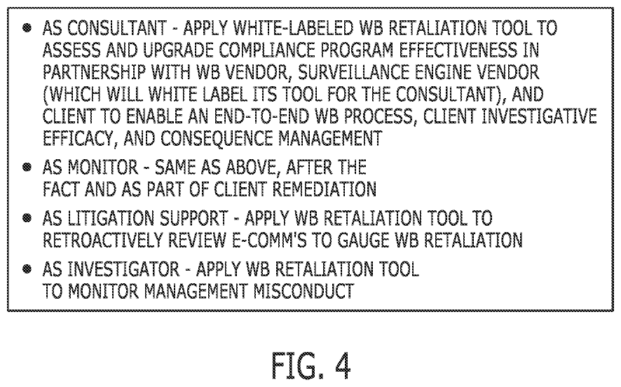

Referring to FIGS. 1 through 4, FIG. 1 is a flowchart 10 illustrating initial coordination to use a retaliation monitoring tool according to an embodiment of the present invention. An organization or individual consultant signs a non-disclosure agreement (NDA), a strategic partnership agreement, and a licensing agreement with a whistleblowing vendor and with a surveillance tech vendor. The retaliation monitoring tool may be white labeled and marketed to other organizations.

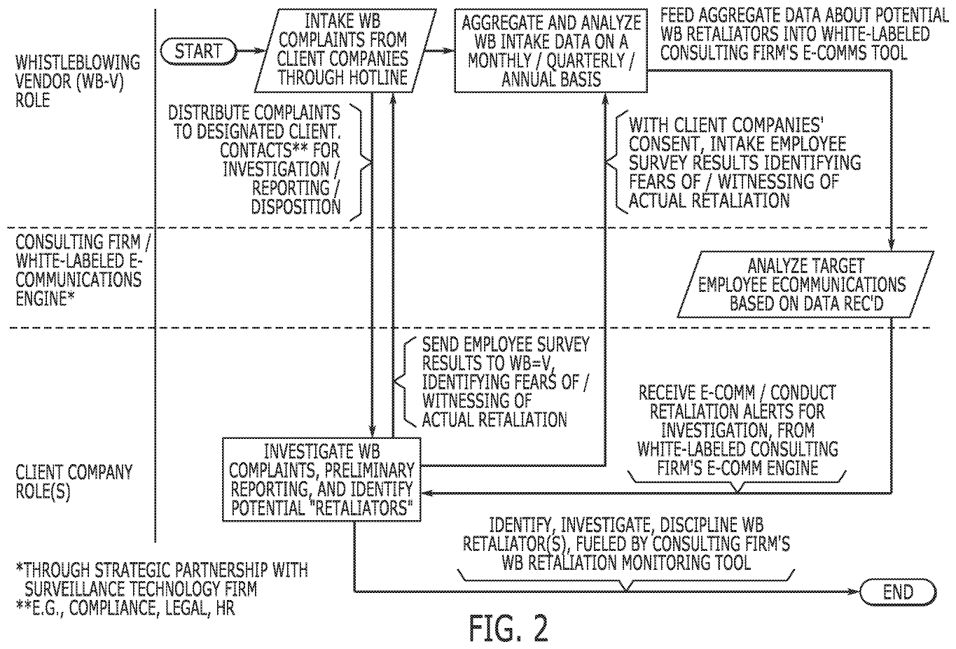

As described in FIGS. 2-4, the whistleblowing vendor receives whistleblower complaints through a hotline, collecting data in an intake process. The whistleblowing vendor distributes the complaints to designated contacts (e.g., personnel in compliance, human resources, and/or legal departments) at the client company to be investigated, reported, and/or resolved. The data may be aggregated and analyzed on a regular basis, such as monthly, quarterly, or annually. The aggregated data about potential whistleblower retaliators may be fed into the white-labeled consulting firm's e-communications tool.

The e-communications engine analyzes target employee e-communications (including but not limited to emails, texts, voice, social media, video conference recordings) based on the received data to flag any terms that may be considered part of a retaliatory lexicon and to flag any patterns of behavior that may indicate retaliation, such as discussing the whistleblower with other personnel, either implicitly or explicitly. Based on the analysis, the consulting firm may assess compliance program effectiveness and upgrade the program to improve its effectiveness, including improving the whistleblower process, client investigative efficacy, and consequence management. The e-communications engine may also be used retroactively to support retaliation litigation and may be used to monitor management misconduct.

The client company may identify potential retaliators, who may ultimately be disciplined including termination, since retaliation is illegal. The results of the investigation may be added to the data analyzed by the whistleblowing vendor. The client company may also administer an employee survey to evaluate employee fears of retaliation and/or to collect statistics and/or anecdotes regarding retaliation witnessed by the employees. The client company may send the results to the whistleblowing vendor to incorporate any complaints resulting from the survey.

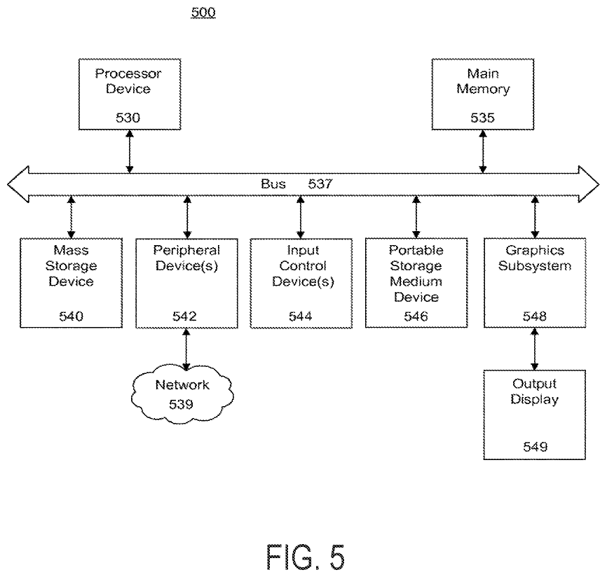

FIG. 5 is a block diagram of a general and/or special purpose computer 500, which may be a general and/or special purpose computing device, in accordance with some of the example embodiments of the invention. The computer 500 may be implemented as a conventional computer system, an embedded controller, a laptop, a server, a mobile device, a smartphone, a wearable computer, a set-top box, a kiosk, a vehicular information system, one more processor associated with a television, a customized machine, any other hardware platform, or any combination or multiplicity thereof. Computer 500 may be a distributed system configured to function using multiple computing machines interconnected via a data network or bus system.

Computer 500 may include without limitation a processor 530, a graphics processing unit (GPU), Application Specific Integrated Circuit (ASIC), or any combination thereof. Computer 500 may also include a main memory 535, and an interconnect bus 537. The processor 530 may include without limitation a single microprocessor or may include a plurality of microprocessors for configuring the computer 500 as a multi-processor system.

Processor 530 may be configured to execute code or instructions to perform the operations and functionality described herein, manage request flow and address mappings, and to perform calculations and generate commands. Processor 530 may be configured to monitor and control the operation of the components in computer 500. Processor 530 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof.

Processor 530 may be a single processing unit, multiple processing units, a single processing core, multiple processing cores, special purpose processing cores, co-processors, or any combination thereof. According to certain embodiments, processor 530 along with other components of computer 500 may be a virtualized computing machine executing within one or more other computing machines.

The main memory 535 stores, among other things, instructions and/or data for execution by the processor 530. The main memory 535 may include banks of dynamic random-access memory (DRAM), as well as cache memory.

The computer 500 may further include a mass storage device(s) 540, peripheral device(s) 542, non-transitory storage medium device(s) 546, input control device(s) 544, a graphics subsystem 548, and/or a display 549. For explanatory purposes, all components in computer 500 are shown in FIG. 5 as being coupled through bus 537. However, computer 500 is not so limited. Devices and systems of the computer 500 may be coupled through one or more data transport means. For example, processor 530 and/or the main memory 535 may be coupled through a local microprocessor bus. Mass storage 540, peripheral device(s) 542, portable storage medium device(s) 546, and/or graphics subsystem 548 may be coupled via one or more input/output (I/O) buses.

Mass storage 540 may include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof.

Mass storage 540 may store one or more operating systems, application programs and program modules, data, or any other information. Mass storage may be part of, or connected to, computer 500. Mass storage 540 may also be part of one or more other computing machines that are in communication with computer 500, such as servers, database servers, cloud storage, network attached storage, and so forth.

Portable storage medium device 546 operates in conjunction with a nonvolatile portable storage medium, such as, for example, a compact disc read only memory (CD-ROM), to input and output data and code to and from computer 500. In some embodiments, the software for storing information may be stored on a portable storage medium and may be inputted into computer 500 via portable storage medium device 546.

Peripheral device(s) 542 may include any type of computer support device, such as, for example, an input/output (I/O) interface configured to add additional functionality to computer 500. For example, peripheral device(s) 542 may include a network interface card for interfacing computer 500 with network 539.

Input control device(s) 544 provides a portion of the user interface for a user of computer 500. Input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. To display textual and graphical information, computer 500 may include graphics subsystem 548 and output display 549. Output display 549 may include a cathode ray tube (CRT) display and/or a liquid crystal display (LCD). Graphics subsystem 548 receives textual and graphical information and processes the information for output-to-output display 549.

Computer 500 may operate in a networked environment using logical connections through network 539 to one or more other systems or computing machines across network 539. Network 539 may include wide area networks (WAN), local area networks (LAN), intranets, the Internet, wireless access networks, wired networks, mobile networks, telephone networks, optical networks, or combinations thereof.

Network 539 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

Each component of computer 500 may represent a broad category of a computer component of a general and/or special purpose computer. Components of computer 500 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any software configuration. They may find applicability in any computing or processing environment. The terms “computer-readable”, “machine-accessible medium” or “machine-readable medium” used herein shall include any medium that is configured for storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding (instructions) may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures, methods, processes, algorithms, and models described above.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence or combined into a single step/process. The scope of the claims is intended to broadly cover the disclosed embodiments and any such modification. It should be understood, of course, that the foregoing relates to exemplary embodiments of the invention and that modifications may be made without departing from the spirit and scope of the invention as set forth in the following claims.

What is claimed is:

1. A processor-implemented whistleblower retaliation surveillance method comprising:
executing processor-executable instructions to:
receive whistleblower identification and identification of electronic communications to surveil;
compare contents of the electronic communications to patterns of communication indicative of whistleblower retaliation; and
issue alerts when the patterns of communication indicative of whistleblower retaliation are detected in the electronic communications.

2. The processor-implemented whistleblower retaliation surveillance method of claim 1, wherein the patterns of communication are implied.

3. The processor-implemented whistleblower retaliation surveillance method of claim 1, wherein the patterns of communication identify systemic and/or pervasive patterns of behavior.

4. The processor-implemented whistleblower retaliation surveillance method of claim 1, wherein the patterns of communication reveal evidence of a coverup.

5. The processor-implemented whistleblower retaliation surveillance method of claim 1, wherein the alerts are evaluated to confirm whether bona fide retaliation has occurred.

6. The processor-implemented whistleblower retaliation surveillance method of claim 1, wherein the patterns of communication include any combination of a retaliatory lexicon, retaliatory behavior, workplace harassment, unusual behavior, and collusion.

7. The processor-implemented whistleblower retaliation surveillance method of claim 1, wherein the electronic communications are selected from the group consisting of emails, voicemail, texts, recordings of video conferences, and social media, and any combination thereof.

8. A computing system operative to monitor communications for indicia of whistleblower retaliation, comprising:
a retaliation model subsystem operative to specify patterns of communication indicative of whistleblower retaliation;
a computer readable memory;
a processor in communication with the retaliation model subsystem and with the computer readable memory, said processor operative to execute computer readable instructions that, when executed, perform the processor-implemented whistleblower retaliation surveillance method of claim 1; and
a reporting subsystem operative to deliver the alerts to designated personnel.

9. A processor-readable, non-transitory, physical medium storing processor-executable instructions to perform the processor-implemented whistleblower retaliation surveillance method of claim 1.
